(19) United States
(12) Patent Application Publication
(10) Pub. No.: US 2024/0335845 A1
(43) Pub. Date: Oct. 10, 2024

(54) Film Deposition Apparatus

(71) Applicant: TATSUTA ELECTRIC WIRE & CABLE CO., LTD., Osaka (JP)

(72) Inventor: Masaki HIRANO, Kizugawa-shi, Kyoto (JP)

(21) Appl. No.: 18/695,259

(22) PCT Filed: Sep. 28, 2022
(86) PCT No.: PCT/JP2022/036150

§ 371 Date: Mar. 25, 2024

(30) Foreign Application Priority Data
Oct. 1, 2021 (JP) 2021-162947

(51) Int. Cl. B05B 7/04; B05B 7/00; B05B 7/14

(52) U.S. Cl. CPC B05B 7/04; B05B 7/0075; B05B 7/1463; B05B 7/149

(57) ABSTRACT

The film deposition apparatus used in a thermal spraying method includes a spray gun which includes a nozzle, a powder supply unit that supplies a powder to the spray gun as a film deposition raw material, and a gas supply unit that supplies a working gas to the spray gun. The nozzle includes a stainless pipe as a nozzle pipe, a ceramic pipe connected to an upstream portion of the stainless pipe through which the working gas flows, and a nozzle holder into which the ceramic pipe is inserted. The nozzle holder includes a first portion extending in a first direction in which the working gas flows through the nozzle holder. The film deposition apparatus further includes a pipe which connects the powder supply unit and the first portion. A portion of the pipe, which is connected to the first portion, extends in a second direction intersecting the first direction.

### TECHNICAL FIELD

The present disclosure relates to a film deposition apparatus.

### BACKGROUND ART

Conventionally, a cold spraying method has been known as one of thermal spraying methods. In the cold spraying method, a film is formed on a substrate by spraying a film deposition raw material together with a carrier gas onto the substrate from a nozzle tip of a spray gun. The cold spraying method can suppress oxidation and thermal degradation of the film deposition raw material in the air, and can form a dense and highly adherent film on the substrate.

In the nozzle used in the cold spraying method, a “blockage” may be formed on an inner wall surface of a passage through which the carrier gas and the film deposition material flow. The blockage is caused by the adhesion of the powder to the inner wall surface of the passage in the film deposition step, which narrows the passage.

If the blockage on the inner wall surface of the passage becomes greater, the film deposition material and the working gas are difficult to flow through the passage, which makes the film deposition on the substrate impossible. Therefore, Japanese Patent No. 6404532 (PTL 1) and Japanese Patent No. 5877590 (PTL 2) disclose a cold spray apparatus that includes a nozzle capable of preventing the adhesion of a film deposition raw material powder to an inner wall surface of the nozzle.

### CITATION LIST

### Patent Literature

PTL 1: Japanese Patent No. 6404532
PTL 2: Japanese Patent No. 5877590

### SUMMARY OF INVENTION

### Technical Problem

In addition to the blockage, an “abrasion” may occur on the inner wall surface of the nozzle passage. The abrasion is caused by the collision of the film deposition raw material powder with the inner wall surface of the passage during the film deposition step. If the abrasion on the inner wall surface of the passage becomes greater, the flow of the working gas flowing through the passage may be changed from the normal flow. This may cause unintended change to the film deposited on the substrate. However, none of Japanese Patent No. 6404532 and Japanese Patent No. 5877590 discloses any countermeasure from the viewpoint of suppressing abrasion.

From the viewpoint of suppressing abrasion and improving durability, it is conceivable to use a hard material for the nozzle. In Japanese Patent No. 6404532, in order to suppress the blockage, the entire nozzle is made of a metal material. If the entire nozzle is made of a hard material such as a ceramic material, the manufacturing cost of the nozzle will become expensive. This is because the use of hard materials requires high-precision machining and polishing.

It is an object of the present disclosure to provide a film deposition apparatus including a nozzle capable of suppressing abrasion on an inner wall surface of a passage and improving durability at low cost.

### Solution to Problem

The film deposition apparatus according to the present disclosure is a film deposition apparatus used in a thermal spraying method. The film deposition apparatus includes a nozzle, a powder supply unit that supplies a powder to the nozzle as a film deposition raw material, and a gas supply unit that supplies a working gas to the nozzle. The nozzle includes a nozzle pipe, a ceramic pipe connected to an upstream portion of the nozzle pipe through which the working gas flows, and a nozzle holder into which the ceramic pipe is inserted. The nozzle holder includes a first portion extending in a first direction in which the working gas flows through the nozzle holder. The film deposition apparatus further includes a pipe which connects the powder supply unit and the first portion. A portion of the pipe, which is connected to the first portion, extends in a second direction intersecting the first direction.

### Advantageous Effects of Invention

According to the above, it is possible to provide a film deposition apparatus including a nozzle capable of suppressing abrasion on an inner wall surface of a passage and improving durability at low cost.

### BRIEF DESCRIPTION OF DRAWINGS

FIG. 1 is a schematic view illustrating a configuration of a film deposition apparatus according to the present embodiment;

FIG. 2 is a perspective view illustrating members of a nozzle of FIG. 1 in a disassembled state;

FIG. 3 is a schematic view illustrating a first example configuration of a nozzle in the film deposition apparatus of FIG. 1;

FIG. 4 is a schematic view illustrating a second example configuration of a nozzle in the film deposition apparatus of FIG. 1;

FIG. 5 is a schematic view illustrating a third example configuration of a nozzle in the film deposition apparatus of FIG. 1;

FIG. 6 is a first cross-sectional view schematically illustrating a ceramic pipe and a stainless steel pipe adjacent thereto;

FIG. 7 is a second cross-sectional view schematically illustrating a ceramic pipe and a stainless steel pipe adjacent thereto;

FIG. 8 is a flowchart illustrating a film deposition method according to the present embodiment;

FIG. 9 is a graph illustrating the relationship between each elapsed time during which the working gas and the film deposition material were continuously sprayed from the film deposition apparatus and the thickness of a film deposited by the film deposition apparatus after each elapsed time;

FIG. 10 is a schematic view illustrating locations where an abrasion is likely to occur in the ceramic pipe of FIG. 3; and

FIG. 11 is a photograph illustrating the observation results of the inside of a stainless steel pipe observed from an inlet end face of the stainless steel pipe after the working gas and the film deposition material were continuously sprayed from the film deposition apparatus for 12 hours.

### DESCRIPTION OF EMBODIMENTS

Hereinafter, embodiments of the present disclosure will be described. It should be noted that the same components are denoted by the same reference numerals, and the description thereof will not be repeated.

### <Configuration of Film Deposition Apparatus>

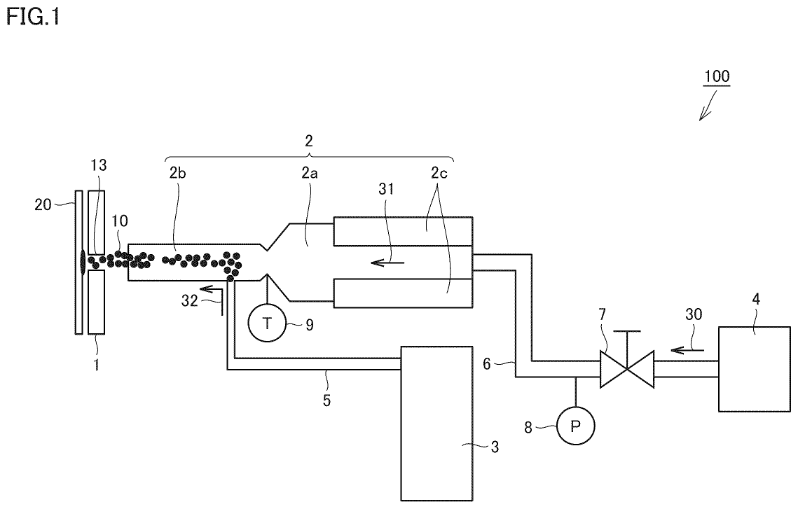

FIG. 1 is a schematic view illustrating a configuration of a film deposition apparatus according to the present embodiment. The film deposition apparatus 100 illustrated in FIG. 1 mainly includes a spray gun 2 including a nozzle 2b, a powder supply unit 3, a gas supply unit 4, and a mask jig 1.

The spray gun 2 mainly includes a spray gun main body 2a, a nozzle 2b, a heater 2c, and a temperature sensor 9. The nozzle 2b is connected to a first end, i.e., a front end of the spray gun main body 2a. A pipe 6 is connected to a second end, i.e., a rear end of the spray gun main body 2a. The pipe 6 is connected to the gas supply unit 4 via a valve 7. The gas supply unit 4 supplies a working gas to the spray gun 2 via the pipe 6. The supply of the working gas from the gas supply unit 4 to the spray gun 2 can be controlled by opening and closing the valve 7. The pipe 6 is installed with a pressure sensor 8. The pressure sensor 8 measures the pressure of the working gas supplied from the gas supply unit 4 to the pipe 6.

The working gas supplied from the second end of the spray gun main body 2a into the spray gun main body 2a is heated by the heater 2c. The heater 2c is disposed on the second end side of the spray gun main body 2a. The working gas flows through the spray gun main body 2a in a direction indicated by an arrow 31. The temperature sensor 9 is connected to a connection portion between the nozzle 2b and the spray gun main body 2a. The temperature sensor 9 measures the temperature of the working gas flowing through the spray gun main body 2a.

A pipe 5 is connected to the nozzle 2b. The pipe 5 is also connected to the powder supply unit 3. The powder supply unit 3 supplies a powder to the nozzle 2b of the spray gun 2 via the pipe 5 as a film deposition raw material.

The mask jig 1 is disposed between a substrate 20 and the spray gun 2. The mask jig 1 is formed with a through hole 13. The through hole 13 defines a film deposition region on a surface of the substrate 20.

### <Operation of Film Deposition Apparatus>

In the film deposition apparatus 100 illustrated in FIG. 1, as indicated by an arrow 30, the working gas is supplied from the gas supply unit 4 to the spray gun 2 via the pipe 6. Thereby, the working gas is supplied to the nozzle 2b. The working gas may be, for example, nitrogen, helium, dry air, or a mixture thereof. The pressure of the working gas is, for example, about 1 MPa. The flow rate of the working gas is, for example, 300 L/min or more and 500 L/min or less. The working gas supplied to the second end of the spray gun main body 2a is heated by the heater 2c. The heating temperature of the working gas is appropriately set according to the composition of the film deposition raw material, and may be, for example, 100° C. or higher and 500° C. or lower. The working gas flows from the spray gun main body 2a to the nozzle 2b. As indicated by an arrow 32, the powder 10 is supplied as the film deposition raw material from the powder supply unit 3 to the nozzle 2b via the pipe 5. The powder 10 may be, for example, nickel powder, tin powder, or a mixture of the tin powder and the zinc powder. The particle diameter of the powder 10 is, for example, 1 μm or more and 50 μm or less.

The powder 10 supplied to the nozzle 2b is sprayed from a tip of the nozzle 2b toward the substrate 20 together with the working gas. The mask jig 1 is disposed to face the surface of the substrate 20. The sprayed powder 10 passes through the through hole 13 of the mask jig 1 to reach the surface of the substrate 20. A film is formed on the surface of substrate 20 with the sprayed powder 10 serving as the raw material.

<Configuration of Nozzle 2b>

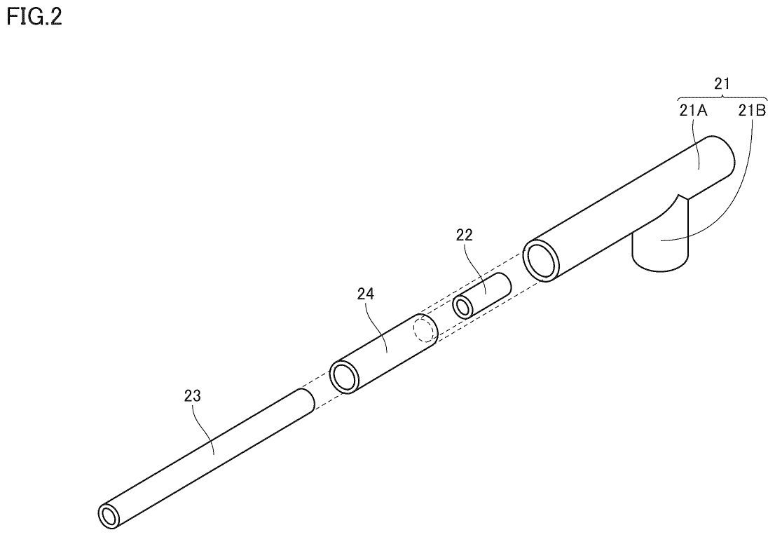

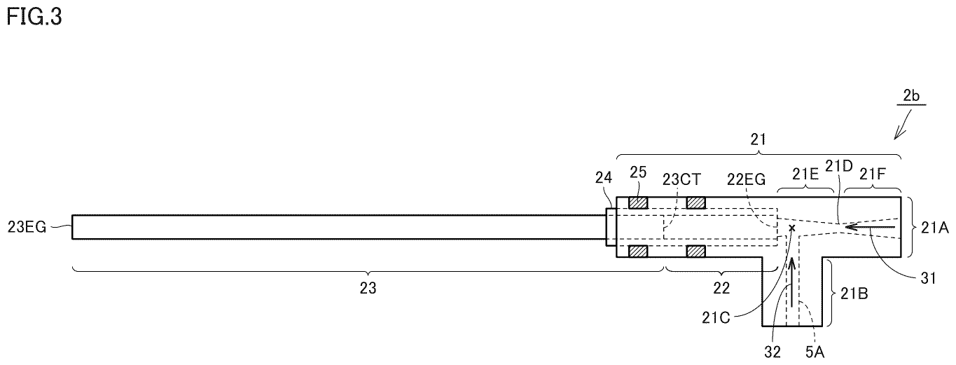

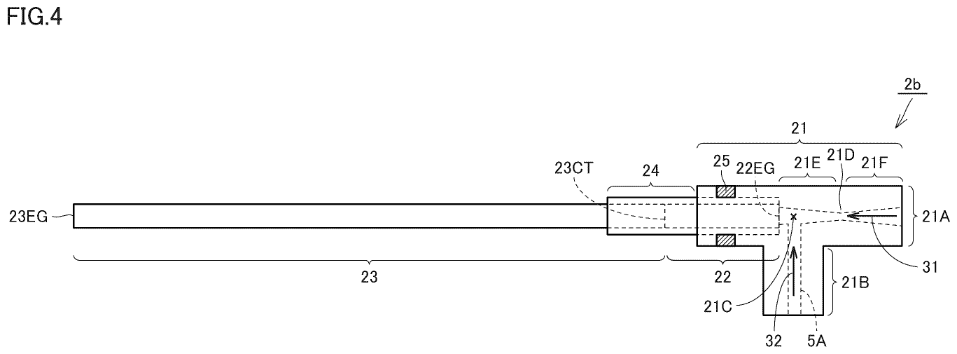

FIG. 2 is a perspective view illustrating members of the nozzle of FIG. 1 in a disassembled state. FIG. 3 is a schematic view illustrating a first example configuration of the nozzle in the film deposition apparatus of FIG. 1. FIG. 4 is a schematic view illustrating a second example configuration of the nozzle in the film deposition apparatus of FIG. 1. In FIGS. 3 and 4, a portion located inside a member and not visible from the outside is indicated by a dotted line. With reference to FIGS. 2, 3 and 4, the nozzle 2b includes a nozzle holder 21, a ceramic pipe 22, and a stainless steel pipe 23. The right end of the nozzle 2b in FIGS. 3 and 4 is connected to the spray gun main body 2a in FIG. 1. As indicated by an arrow 31 in FIGS. 3 and 4, the working gas flows from the right side to the left side through the nozzle 2b (as illustrated in FIG. 1).

The nozzle holder 21 includes a first portion 21A extending along the horizontal direction in which the working gas flows through the spray gun 2, and a second portion 21B extending in the vertical direction intersecting (for example, orthogonal to) the first portion 21A. The second portion 21B is not limited to extending perpendicular to the first portion 21A, it may extend in a direction with some angle relative to the vertical direction. In the nozzle holder 21, the first portion 21A and the second portion 21B are integrated to each other. The first portion 21A is configured to allow the working gas to flow from the spray gun main body 2a into the ceramic pipe 22. The second portion 21B is configured to allow the powder 10 to flow from the powder supply unit 3 via the pipe 5 into the first portion 21A.

The pipe 5 is connected to the second portion 21B of the nozzle holder 21, and extends inside the second portion 21B in the vertical direction. A portion of the pipe 5, which is adjacent to the intersection portion 21C between the pipe 5 and a hollow space (to be described later) inside the first portion 21A and is located inside the nozzle holder 21 (see especially FIGS. 3 and 4), is hereinafter referred to as a pipe 5A. The pipe 5A is a hollow space extending inside the second portion 21B in the vertical direction. The pipe 5A extends in the vertical direction intersecting the horizontal direction (first direction) in which the working gas flows through the spray gun 2. The pipe 5A is connected to the hollow space (to be described later) inside the first portion 21A.

The hollow space extends in the horizontal direction of FIG. 3 inside the first portion 21A. The hollow space is formed as a passage for the working gas and the powder 10. The hollow space may extend obliquely with respect to the outer edge of the first portion 21A extending in the horizontal direction. In other words, the inner diameter of the hollow space may gradually increase or decrease. Specifically, the hollow space includes a throat portion 21D, an extension portion 21E, and an extension portion 21F. The throat portion 21D is a portion of the hollow space that has the smallest inner diameter in the first portion 21A. The throat portion 21D is formed on the upstream side (the right side in FIGS. 3 and 4) of the working gas with respect to the intersection portion 21C between the first portion 21A and the second portion 21B (to be described below). Further, the extension portion is a portion other than the throat portion 21D, i.e., a portion that extends obliquely in such a manner that the inner diameter of the hollow space gradually increases as the distance from the throat portion 21D increases. The expansion portion 21E is a passage on the downstream side (the left side in FIGS. 3 and 4) of the throat portion 21D, and the expansion portion 21F is a passage on the upstream side of the throat portion 21D.

The hollow space (the throat portion 21D, the extension portion 21E and the extension portion 21F) of the first portion 21A and the hollow space (the pipe 5A) of the second portion 21B intersect at the intersection portion 21C of the nozzle holder 21. The working gas flowing through the hollow space of the first portion 21A and the powder 10 flowing through the hollow space of the second portion 21B merge at the intersection portion 21C. The working gas containing the film deposition raw material flows toward the downstream side of the intersection portion 21C in the first portion 21A.

The ceramic pipe 22 is inserted into the nozzle holder 21 on the downstream side of the intersection portion 21C in the first portion 21A. The stainless steel pipe 23 is connected to the downstream end of the ceramic pipe 22. The ceramic pipe 22 and the stainless steel pipe 23 may be connected to each other via a joint (not shown). In the first example of FIG. 3, a connection portion 23CT between the ceramic pipe 22 and the stainless steel pipe 23 is housed in the nozzle holder 21. In other words, in FIG. 3, the entire ceramic pipe 22 and a part of the stainless steel pipe 23 are housed in the nozzle holder 21. On the other hand, in the second example of FIG. 4, the connection portion 23CT between the ceramic pipe 22 and the stainless steel pipe 23 is disposed outside the nozzle holder 21. In other words, in FIG. 4, only a part of the ceramic pipe 22 is housed in the nozzle holder 21, and the entire stainless steel pipe 23 is disposed outside the nozzle holder 21. Thus, the configuration illustrated in FIG. 3 and the configuration illustrated in FIG. 4 are different from each other at this point. Either the configuration illustrated in FIG. 3 or the configuration illustrated in FIG. 4 may be adopted in the present embodiment.

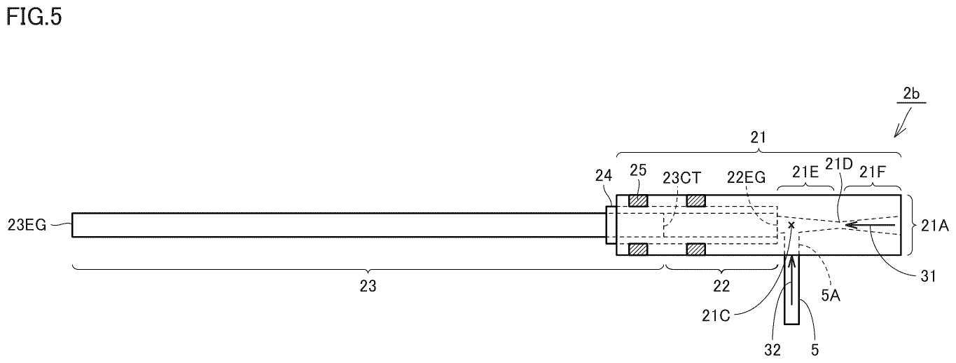

FIG. 5 is a schematic view illustrating a third example configuration of the nozzle in the film deposition apparatus of FIG. 1. With reference to FIG. 5, in the third example configuration, the nozzle holder 21 does not include a second portion 21B, and includes only a first portion 21A extending in the horizontal direction. Thus, as illustrated in FIG. 5, the pipe 5A is adjacent to the intersection portion 21C, but is disposed outside the nozzle holder 21. Similar to that illustrated in FIGS. 3 and 4, the pipe 5A in FIG. 5 extends in the vertical direction intersecting the horizontal direction (first direction) in which the working gas flows through the spray gun 2. The pipe 5A is connected to the hollow space of the first portion 21A (which will be described later).

A guide member 24 may be provided outside of the ceramic pipe 22 and the stainless steel pipe 23 in the radial direction. The guide member 24 has a cylindrical shape, and is disposed to surround the connection portion 23CT between the ceramic pipe 22 and the stainless steel pipe 23 from the outside in the radial direction. The guide member 24 is disposed across the ceramic pipe 22 and the stainless steel pipe 23. The guide member 24 surrounds a curved surface (a side surface) extending around the outer edges of the ceramic pipe 22 and the stainless steel pipe 23 from the outside in the radial direction, and comes into contact with both the ceramic pipe 22 and the stainless steel pipe 23. In particular, the guide member 24 contacts the connection portion 23CT between the ceramic pipe 22 and the stainless steel pipe 23, a portion of the ceramic pipe 22 and a portion of the stainless steel pipe 23 that are adjacent to the connection portion 23CT in the extending direction. The guide member 24 is adjustable such that the center axis of the ceramic pipe 22 and the center axis of the stainless steel pipe 23 is aligned with each other and the two center axes extend in a straight line.

The working gas and the film deposition raw material merged at the intersection portion 21C then flow through the ceramic pipe 22 and the stainless steel pipe 23 in a direction from the right side to the left side in FIGS. 3 and 4.

The guide member 24 may be fixed to the ceramic pipe 22 and the stainless pipe 23. It is preferable that a threaded member 25 is disposed on the outer side of the guide member 24 in the radial direction, for example. The threaded member 25 has male threads and female threads, which can engage with each other. The male threads of the threaded member 25 may be, for example, fixed as an annular member on a curved surface extending along the outer edge of the guide member 24, or may be directly formed on the outer edge of the guide member 24. Alternatively, if the guide member 24 is not disposed, the male threads may be fixed on the outer curved surface of the ceramic pipe 22 and the stainless steel pipe 23, or the male threads may be directly formed on the outer curved surface. The female threads may be formed on an inner wall of the hollow space of the first portion 21A of the nozzle holder 21 into which the ceramic pipe 22 is inserted, or may be a nut fixed to the nozzle holder 21. The threaded member 25 fixes the ceramic pipe 22 and the stainless steel pipe 23 to the nozzle 2b (the nozzle holder 21).

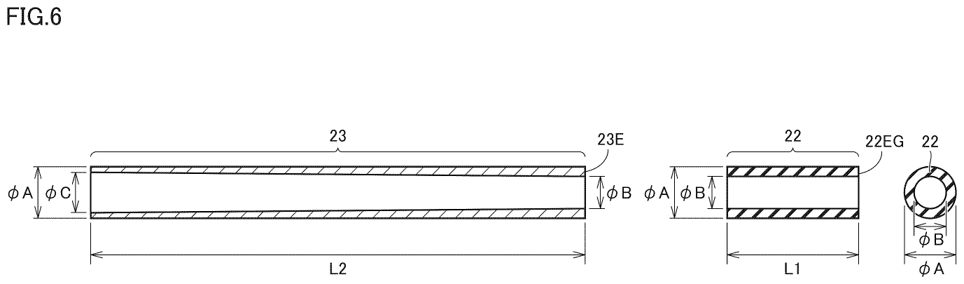

The extension portion 21E is connected to the ceramic pipe 22, and as illustrated in FIGS. 3 to 5, the inner diameter (the diameter of the inner wall surface) of the downstream end of the extension portion 21E is smaller than the outer diameter (the diameter of the outer wall surface) of the ceramic pipe 22. More specifically, the inner diameter of the downstream end of the extension portion 21E is substantially equal to the inner diameter of an upstream end (an inlet end face 22EG) of the ceramic pipe 22. FIG. 6 is a first cross-sectional view schematically illustrating a ceramic pipe and a stainless steel pipe adjacent thereto. With reference to FIG. 6, the ceramic pipe 22 may have a cylindrical shape, an inner wall surface thereof extending substantially parallel to the extending direction (the horizontal direction in FIG. 6). The length of the ceramic pipe 22 in the extending direction is L1. The cross section of the ceramic pipe 22 intersecting the extending direction thereof is circular, an outer wall surface of which has a diameter of ϕA and an inner wall surface of which has a diameter of ϕB. For example, L1 is 15 mm, ϕA is 6 mm, and ϕB is 4 mm. However, the dimension of each part is not limited thereto.

On the other hand, the stainless steel pipe 23 adjacent to the ceramic pipe 22 may have an inner wall surface that extends slightly inclined with respect to the extending direction (the horizontal direction in FIG. 6). Specifically, the stainless steel pipe 23 has a length of L2 in the extending direction. The cross section of the stainless steel pipe 23 intersecting the extending direction thereof is circular, an outer wall surface of which has a diameter of ϕA (which is the same as that of the ceramic pipe 22) and an inner wall surface of which has such a diameter that gradually changes from ϕB (which is the same as that of the ceramic pipe 22) to ϕC. An upstream end face (an inlet end face 23E) of the stainless steel pipe 23 has an inner wall diameter of ϕB. For example, L2 is 120 mm, and ϕC is 5 mm.

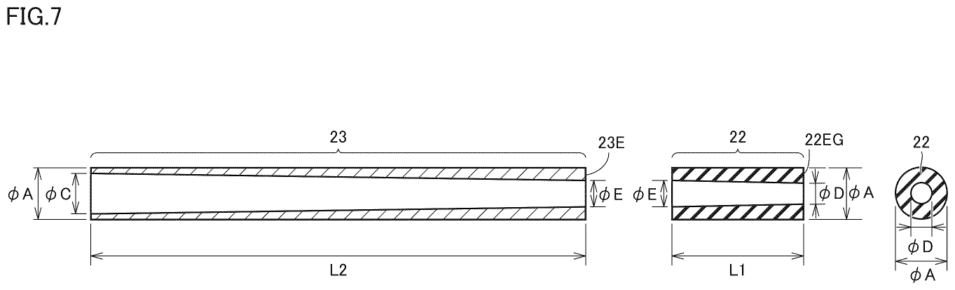

FIG. 7 is a second cross-sectional view schematically illustrating a ceramic pipe and a stainless steel pipe adjacent thereto. With reference to FIG. 7, the ceramic pipe 22 may have an inner wall surface that extends slightly inclined with respect to the extending direction (the horizontal direction in FIG. 6). Specifically, the cross section of the ceramic pipe 22 intersecting the extending direction thereof is circular, an inner wall surface of which has such a diameter that gradually changes from ϕD to ϕE. For example, ϕD is 3 mm and ϕE is 3.5 mm, but the diameter is not limited thereto. The angle at which the inner wall surface of the ceramic pipe 22 is inclined with respect to the side surface of the outer edge is, for example, 5° or less, and more preferably 3° or less. As illustrated in FIG. 1, the outer wall surface of the stainless steel pipe 23 is circular with a diameter of ϕA, and the inner wall surface thereof is circular with such a diameter that gradually changes from ϕE to ϕC. As illustrated in FIG. 7, the inner wall surfaces of the downstream end of the ceramic pipe 22 and the upstream end of the stainless steel pipe 23 (the inlet end face 23E) may have the same diameter 9E, and the inclination angle between the inner wall surface of the ceramic pipe 22 and the inner wall surface of the stainless steel pipe 23 may be the same. In this case, by connecting the ceramic pipe 22 and the stainless steel pipe 23, the inner wall surface may extend from the inlet end face 22EG of the upstream end of the ceramic pipe 22 to the outlet end face 23EG of the downstream end of the stainless steel pipe 23 at the same inclination angle.

The cross-sectional shape of the outer wall surface and/or the inner wall surface of the ceramic pipe 22 illustrated in FIGS. 6 and 7 may be circular as described above, or may be elliptical.

<Material of Each Member of Nozzle 2b>

The nozzle holder 21 is made of brass. The nozzle holder 21 is supplied with the powder 10 (the film deposition raw material) from the powder supply unit 3 through the pipe 5. However, as illustrated in FIGS. 3 and 4, the ceramic pipe 22 is inserted into the nozzle holder 21 on the downstream side of the intersection portion 21C. The flow direction of the working gas and the powder 10 is changed from the vertical direction to the horizontal direction at the intersection portion 21C. In the region adjacent to the changing portion of the flow direction of the powder 10, the powder 10 collides with the inner wall surface of the ceramic pipe 22 rather than the inner wall surface of the hollow space of the nozzle holder 21. Since there is less damage to the inner wall surface of the hollow space of the nozzle holder 21, the material of the nozzle holder 21 does not need to be particularly hard. Further, on the upstream side of the powder 10 and the working gas further than the intersection portion 21C, there is little possibility of the powder 10 colliding with the nozzle holder 21, and thereby, it is not necessary to particularly increase the hardness of the nozzle holder 21. Thus, the nozzle holder 21 is made of brass.

The ceramic pipe 22 is made of a ceramic material. Specifically, the ceramic pipe 22 is made of a material containing, as a main component, any one selected from the group consisting of zirconia, silicon nitride, and alumina. The hardness of the ceramic pipe 22 is preferably higher than that of the ceramic powder before molding, for example. Specifically, the hardness of the ceramic pipe 22 is 1000 HV or more, and more preferably 1200 HV or more. The stainless steel pipe 23 is made of stainless steel such as SUS304, SUS410, or SUS430. The guide member 24 is made of copper.

### Functions and Effects

The film deposition apparatus 100 according to the present disclosure is used in a thermal spraying method. The film deposition apparatus 100 includes a nozzle 2b, a powder supply unit 3 that supplies a powder 10 to the nozzle 2b as a film deposition raw material, and a gas supply unit 4 that supplies a working gas to the nozzle 2b. The nozzle 2b includes a stainless steel pipe 23 as a nozzle pipe, a ceramic pipe 22 connected to an upstream portion of the stainless steel pipe 23 through which the working gas flows, and a nozzle holder 21 into which the ceramic pipe 22 is inserted. The nozzle holder 21 includes a first portion 21A extending in a first direction in which the working gas flows through the nozzle holder 21. The film deposition apparatus further includes a pipe 5 which connects the powder supply unit 3 and the first portion 21A. The pipe 5A, which is a portion of the pipe 5 connected to the first portion 21A, extends in a second direction intersecting the first direction.

In the film deposition apparatus 100, the pipe 5A, which is a portion of the pipe 5 to which the powder 10 is supplied and is connected to the nozzle 2b (the extension portion 21E, i.e., the hollow space), extends in the second direction intersecting the first direction in which the working gas flows. Therefore, the film deposition apparatus 100 is a so-called radial injection film deposition apparatus used at low pressure (the pressure of the working gas is 1 MPa or less). In other words, the film deposition apparatus 100 of the present embodiment is different from a so-called axial injection film deposition apparatus to which the working gas and the powder are supplied in the same direction and is operated at high pressure (the pressure of the working gas is greater than 1 MPa).

In the film deposition apparatus 100, the ceramic pipe 22, which is harder than the stainless steel pipe 23, is provided only in a region of the inner wall surface of the passage of the nozzle 2b where an “abrasion” is most likely to occur. This makes it possible to suppress the abrasion on the inner wall surface of the passage of the nozzle 2b by using a hard material which is cheaper as compared with the case where the entire nozzle 2b is formed by a ceramic pipe. This is because a material having a high hardness is less likely to be abraded than a material having a low hardness. Further, according to the above configuration, since the variation (deviation) in the thickness of the film formed on the substrate 20 can be reduced, the durability can be improved. In other words, it is possible to extend the time during which the film can be deposited such that the deviation of the film thickness falls within an allowable range.

Although the ceramic material is harder than stainless steel, but it is more expensive in cost and lower in heat dissipation. Therefore, in the above configuration, the ceramic material used in the nozzle 2b is limited to a minimum, and the stainless steel pipe 23 is provided in a region other than the ceramic pipe 22. Thus, the manufacturing cost can be reduced and the heat accumulated in the pipe can be reduced as compared with the case where the ceramic pipe 22 is disposed in the region where the stainless steel pipe 23 is disposed. The region where the possibility of occurrence of abrasion is high is a portion of the pipe 5 which is connected to the nozzle 2b and located immediately on the downstream of the working gas. Therefore, by providing the ceramic pipe 22 in this region, i.e., on the upstream side of the working gas relative to the stainless steel pipe 23, it is possible to suppress abrasion in this region.

If the pipe of the nozzle 2b accumulates heat, the powder 10 as a film deposition raw material is influenced by the heat, which causes the powder 10 to adhere to each other to become easily enlarged. In such a situation, the enlarged powder 10 may block the passage, which makes it difficult to stably deposit a film on the substrate 20. Therefore, by narrowing the area where the ceramic pipe 22 is disposed, the heat dissipation property of the stainless steel pipe 23, which is higher than that of the ceramic pipe 22, can be used to suppress heat accumulation and prevent the powder 10 from becoming enlarged. This can prevent the passage from being blocked.

The ceramic pipe 22 is preferably disposed in a region adjacent to the intersection portion 21C inside the nozzle holder 21 between the flow path of the working gas and the flow path of the powder 10 and on a downstream side of the working gas flowing through the adjacent region. This region is a region on the inner wall surface of the passage of the nozzle 2b where “abrasion” is most likely to occur. Therefore, by providing the ceramic pipe 22 in this region, it is possible to improve the effect of suppressing abrasion.

In the film deposition apparatus 100, the length L1 of the ceramic pipe 22 along the first direction may be 10 mm or more and 20 mm or less. The length L1 may be 10 mm or more and 18 mm or less, and more preferably 10 mm or more and 15 mm or less. If the length L1 of the ceramic pipe 22 is shorter than the above-mentioned length, the ceramic pipe 22 will not be able to cover the entire region where abrasion is most likely to occur, and the ceramic pipe 22 will be less effective in suppressing abrasion. If the length L1 of the ceramic pipe 22 is longer than the above-mentioned length, the flow of the heat and the working gas the flow of heat and working gas will be reduced in the ceramic pipe 22, and thereby heat may be accumulated in the pipe. This is because ceramic has lower heat dissipation than stainless steel, and cannot dissipate heat in the pipe sufficiently. As a result, the powder 10 may become large due to the influence of heat (and may block the passage of the pipe). If the length L1 of the ceramic pipe 22 is in the above range, both the effect of suppressing abrasion and the effect of heat radiation can be enhanced.

In the film deposition apparatus 100, the ceramic pipe 22 may be made of any one selected from the group consisting of zirconia, silicon nitride, and alumina. Thus, it is possible to suppress abrasion of the ceramic pipe 22 due to the high hardness of the ceramic pipe 22.

The film deposition apparatus 100 further includes a guide member 24 that surrounds the stainless steel pipe 23 and the ceramic pipe 22 (in the radial direction) and contacts the stainless steel pipe 23 and the ceramic pipe 22. The guide member 24 is made of copper. The guide member 24 is made of copper having high thermal conductivity, and is brought into contact with the pipe, whereby heat accumulation of the pipe can be suppressed. Therefore, the passage of the pipe can be prevented from being blocked.

### <Film Deposition Method>

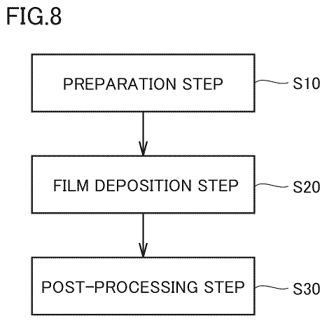

FIG. 8 is a flowchart illustrating a film deposition method according to the present embodiment. With reference to FIG. 8, the film deposition method according to the present embodiment is a film deposition method performed by using the film deposition apparatus 100 illustrated in FIGS. 1 to 7, and mainly includes a preparation step (S10), a film deposition step (S20), and a post-processing step (S30).

The preparation step (S10) includes a step of disposing the mask jig 1 to face the surface of the substrate 20 as illustrated in FIG. 1. In this disposing step, the mask jig 1 is disposed such that the first surface of the mask jig 1 faces the surface of the substrate 20.

In the film deposition step (S20), the powder which serves as the film deposition raw material is sprayed onto the surface of the substrate 20 through the through hole 13 of the mask jig 1 by using the film deposition apparatus 100 according to the cold spraying method. As a result, a film is deposited on the surface of the substrate 20 from the film deposition raw material.

In the post-processing step (S30), the mask jig 1 is removed from the surface of the substrate 20. After that, a necessary process such as treatment of the substrate 20 is performed. In this way, the film can be formed on the surface of the substrate 20.

### EXAMPLE

Hereinafter, an example for confirming the effect of the nozzle 2b in the film deposition apparatus 100 according to the present disclosure will be described. Specifically, the relationship between the deposition time and the deposition thickness of a film by the film deposition apparatus 100 having the nozzle 2b according to the present disclosure was investigated.

### <Samples>

A nozzle 2b including a ceramic pipe 22 made of zirconia and a stainless pipe 23 was prepared according to the present embodiment as illustrated in FIG. 3. Hereinafter, this nozzle is referred to as an “improved nozzle”. Further, a nozzle 2b having a configuration different from that of the present embodiment illustrated in FIG. 3 and including only a stainless steel pipe 23 without a ceramic pipe was prepared. Hereinafter, this nozzle is referred to as a “conventional nozzle”. Each of the improved nozzle and the conventional nozzle was used to form a film on the surface of the substrate 20 which is placed behind the mask jig 1 in the same manner as in FIG. 1. The mask jig 1 has a quadrangular planar shape and was made of stainless steel SUS304. The dimension thereof was 42 mm in width×30 mm in length×3 mm in thickness. The diameter of the through hole 13 was 3 mm.

### <Film Deposition Process>

Each of the improved nozzle 2b and the conventional nozzle was used to form a film on the surface of the substrate according to the cold spraying method. Aluminum powder containing additives was used as the film deposition raw material. The aluminum powder had a spherical shape and a diameter of 10 μm. The material of the substrate was alumina (Al₂O₃). The substrate was a plate having a quadrangular planar shape. The dimension of the substrate was 42 mm in width×30 mm in length×1 mm in thickness.

As the film deposition conditions, dry air was used as the working gas, the temperature of the working gas was 270° C., the flow rate of the working gas was 400 liters/minute, and the pressure of the working gas was about 0.8 MPa. The width of a region on the surface of the mask jig to which the film deposition material was sprayed from the film deposition apparatus was 5 mm. Further, a moving speed (sweeping speed) of moving the region to which the film deposition material was sprayed was set to 10 mm/second so as to include a region on the surface of the mask jig where the through hole is formed. The size of the film deposition range (the region to which the film deposition material was sprayed) on the surface of the mask jig was 5 mm in width×30 mm in length.

Under the above conditions, the film deposition apparatus 100 was used to continuously spray the working gas and the film deposition material from the nozzle 2b for 12 hours. The film was deposited on the surface of the substrate 20 every hour for 13 times in total from a spray-starting time (elapsed time=0 min) to 12 hours (elapsed time=720 min), and the film thickness was measured.

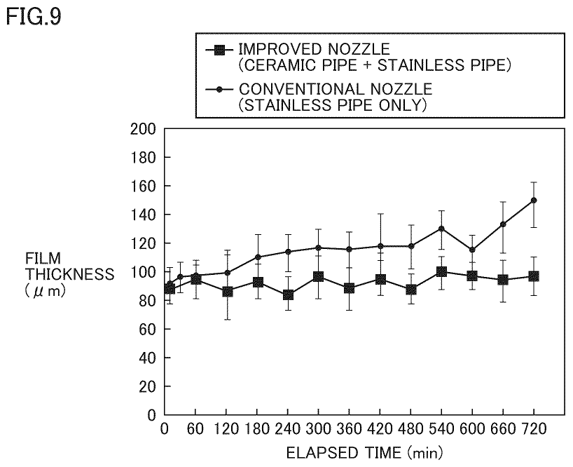

For each of a total number of 13 pieces of the substrates 20 deposited every hour, 1000 locations were extracted from the deposited film and the film thickness of each location was measured using a 3D geometry measuring machine. The maximum value, the minimum value, and the average value of the film thicknesses at 1000 locations were obtained, and the deviation of the film thicknesses on the substrate 20 was obtained from those values. The results are shown in the graph of FIG. 9.

FIG. 9 is a graph illustrating the relationship between each elapsed time during which the working gas and the film deposition material were continuously sprayed from the film deposition apparatus and the thickness of the film deposited by the film deposition apparatus after each elapsed time. With reference to FIG. 9, the horizontal axis of the graph indicates the elapsed time during the working gas and the film deposition material were continuously sprayed from the film deposition apparatus 100, and the vertical axis indicates the thickness of the film deposited after each elapsed time. The plot for each elapsed time indicates the average value of the film thicknesses measured at 1000 locations on the substrate 20 deposited after the spray time. The bars at each elapsed time represent the maximum value and the minimum value of the thickness measured at 1000 locations.

As illustrated in FIG. 9, in the case of using a conventional nozzle, when the elapsed spray time is within 8 hours (480 minutes), the deviation of the film thickness measured at each of the 1000 locations at each time was 10% or less. However, when the elapsed spray time exceeds 8 hours, the deviation of the film thickness measured at each of the 1000 locations at each time was greater than 10%. Then, at the end of 12 hours (720 minutes), the average value of the film thicknesses measured at 1000 locations at each elapsed time (every 60 minutes from 0 minutes to 720 minutes) was 116.4 μm, and the deviation of the film thicknesses was 13.5%. The value of 116.4 μm is the average value of plotted values at each elapsed time for the conventional nozzle in FIG. 9. On the other hand, in the case of using the improved nozzle, even after 12 hours (720 minutes), the average value of the film thicknesses measured at 1000 locations at each time was 92.7 μm, and the deviation of the film thicknesses was 7.4%. The value of 92.7 μm is the average value of plotted values at each elapsed time for the improved nozzle in FIG. 9. The target value, in other words, the allowable range of the deviation of the film thickness is 10% or less. Therefore, the durability time for the conventional nozzle was 8 hours and the durability time for the improved nozzle was 12 hours, and it was confirmed that the durability can be improved by using the improved nozzle.

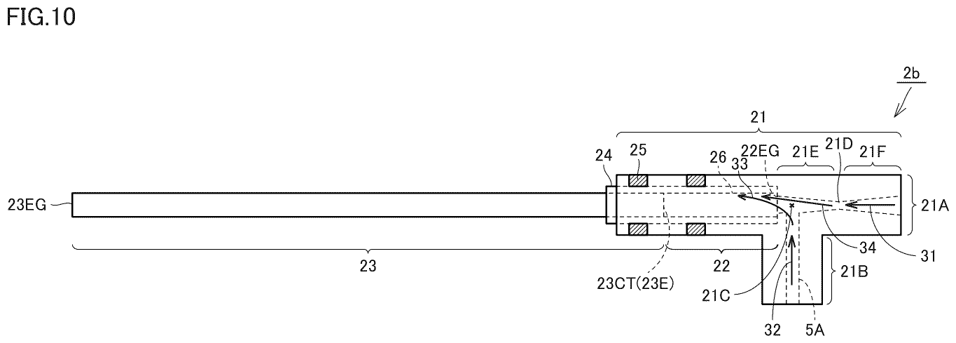

FIG. 10 is a schematic view illustrating locations where abrasion is likely to occur in the ceramic pipe of FIG. 3. With reference to FIG. 10, the illustrated nozzle is an improved nozzle. In the improved nozzle of FIG. 10, as a feature of the present embodiment, the ceramic pipe 22 is disposed at a position including an abrasion portion 26 where abrasion is most likely to occur. The abrasion portion 26 is a portion on the inner wall surface of the ceramic pipe 22 where the flow of the powder diverted from the second direction to the first direction as indicated by an arrow 33 and the flow of the working gas indicated by an arrow 34 collide with each other in the intersection portion 21C or a region adjacent thereto.

In FIG. 10, the ceramic pipe 22 and the stainless steel pipe 23 are connected at a connection portion 23CT. The end face of the stainless steel pipe 23 in the connection portion 23CT corresponds to the upstream end face (the inlet end face 23E) of the stainless steel pipe 23.

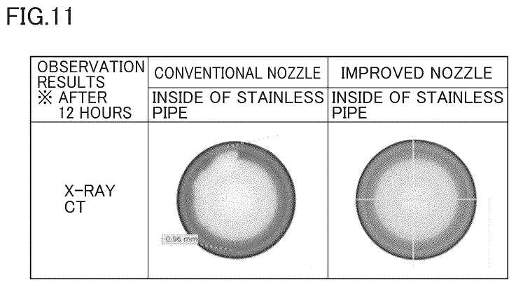

FIG. 11 is a photograph illustrating the observation results of the inside of the stainless steel pipe observed from the inlet end face of the stainless steel pipe after the working gas and the film deposition material were continuously sprayed from the film deposition apparatus for 12 hours. With reference to FIG. 11, the conventional nozzle does not include the ceramic pipe as described above, and only includes the stainless steel pipe 23. Therefore, in the conventional nozzle, the inlet end face 23E of the stainless steel pipe 23 is disposed at a position where the inlet end face 22EG in FIG. 10 is disposed.

The inlet end face 23E of the stainless steel pipe 23 in the conventional nozzle is a region close to the abrasion portion 26 in FIG. 10. More specifically, the inlet end face 23E is a right end face of the stainless steel pipe 23 indicated by a diameter ϕB as illustrated in FIG. 6, and ϕB is 4 mm. In the improved nozzle, the inlet end face 22EG is close to the abrasion portion 26 of FIG. 10 and is a right end face of the ceramic pipe 22 indicated by a diameter ϕB as illustrated in FIG. 6, and ϕB is 4 mm. In both the conventional nozzle and the improved nozzle, the outer diameter ϕA of the stainless steel pipe 23 is 6 mm, and the length L2 thereof is 120 mm (see FIG. 6). The inside of the stainless steel pipe 23 was observed by using X-ray CT from the inlet end face 23E thereof.

In the photograph of FIG. 11, the inside of the stainless steel pipe 23 from the inlet end face 23E to the outlet end face 23EG in both the conventional nozzle and the improved nozzle was observed. In the improved nozzle, the inlet end face 23E is equal to the connection portion 23CT. As illustrated in FIG. 11, in the conventional nozzle, abrasion occurs on the inner wall surface of the stainless steel pipe 23. The abrasion depth was 0.5 mm. On the other hand, in the improved nozzle, no abrasion occurs on the inner wall surface of the stainless steel pipe 23. This is because in the conventional nozzle, the stainless steel pipe 23 is disposed at the position corresponding to the abrasion portion 26 illustrated in FIG. 10, whereas in the improved nozzle, the ceramic pipe 22 is disposed at the position corresponding to the abrasion portion 26 illustrated in FIG. 10.

Although no photograph is shown, no abrasion was found on the ceramic pipe 22 in the improved nozzle. This was confirmed by the fact that the weight of the ceramic pipe 22 did not change before and after the film deposition step.

From this, it has been found that by using the nozzle 2b having the ceramic pipe 22 according to the present disclosure, it is possible to suppress the problem that the flow of the working gas is made unstable, which causes abrasion to occur and makes the film deposition unstable.

It should be understood that the embodiments disclosed herein are illustrative and non-restrictive in all respects. As long as there is no conflict, at least two of the embodiments disclosed herein may be combined. The scope of the present invention is defined by the terms of the claims rather than the description of the embodiments above, and is intended to include any modifications within the scope and meaning equivalent to the terms of the claims.

### REFERENCE SIGNS LIST

1: mask jig; 2: spray gun; 2a: spray gun main body; 2b: nozzle; 2c: heater; 3: powder supply unit; 4: gas supply unit; 5, 5A, 6: pipe; 7: valve; 8: pressure sensor; 9: temperature sensor; 10: powder; 13: through hole; 20: substrate; 21: nozzle holder; 21A: first portion; 21B: second portion; 21C: intersection portion; 21D: throat portion; 21E, 21F: extension portion; 22: ceramic pipe; 22EG, 23E: inlet end face; 23: stainless steel pipe; 23CT: connection portion; 23EG: outlet end face; 24: guide member; 25: threaded member; 26: abrasion portion; 30, 31, 32, 33, 34: arrow

1. A film deposition apparatus used in a thermal spraying method, the film deposition apparatus comprising:
a nozzle;
a powder supply unit that supplies a powder to the nozzle as a film deposition raw material; and
a gas supply unit that supplies a working gas to the nozzle, wherein
the nozzle includes a nozzle pipe, a ceramic pipe connected to an upstream portion of the nozzle pipe through which the working gas flows, and a nozzle holder into which the ceramic pipe is inserted,
the nozzle holder includes a first portion extending in a first direction in which the working gas flows through the nozzle holder,
the film deposition apparatus further comprising a pipe which connects the powder supply unit and the first portion,
a portion of the pipe, which is connected to the first portion, extends in a second direction intersecting the first direction.

2. The film deposition apparatus according to claim 1, wherein the ceramic pipe is disposed in a region adjacent to an intersection portion inside the nozzle holder between a flow path of the working gas and a flow path of the powder and on a downstream side of the working gas flowing through the adjacent region.

3. The film deposition apparatus according to claim 1, wherein a length of the ceramic pipe along the first direction is 10 mm or more and 20 mm or less.

4. The film deposition apparatus according to claim 1, wherein the ceramic pipe is made of any one selected from the group consisting of zirconia, silicon nitride, and alumina.

5. The film deposition apparatus according to claim 1 further comprising:
a guide member that surrounds the nozzle pipe and the ceramic pipe and contacts the nozzle pipe and the ceramic pipe,
the guide member is made of copper.
